(19) United States
(12) Patent Application Publication
(10) Pub. No.: US 2011/0277460 A1
(43) Pub. Date: Nov. 17, 2011

(54) Electrohydraulic Steering System

(75) Inventors: Stephan Brummund, Aschaffenburg (DE); Uwe Neumann, Hoesbach (DE); David Schmitz, Lohr am Main (DE)

(73) Assignee: Robert Bosch GmbH, Stuttgart (DE)

(21) Appl. No.: 13/108,656

(22) Filed: May 16, 2011

(30) Foreign Application Priority Data
May 17, 2010 (DE) 10 2010 020 722.5

(51) Int. Cl. B62D 5/08; B62D 5/09

(52) U.S. Cl. 60/484

(57) ABSTRACT

An electrohydraulic steering system, in particular for mobile working machines having a pressure medium supply system from which a first connection, which acts in a first steering direction, can be supplied via a first feed line, while a second connection, which acts in a second steering direction, can be supplied via a second feed line. In this case, the two feed lines and also a first return line from the first connection to a tank and a second return line from the second connection to the tank are controlled via in each case at least two parallel valves. Therefore, in the event of failure of one of the valves, the at least one valve which is connected in parallel can take over control of the corresponding feed lines or the corresponding return line.

This application claims priority under 35 U.S.C. §119 to patent application no. DE 10 2010 020 722.5, filed May 17, 2010 in Germany, the disclosure of which is incorporated herein by reference in its entirety.

### BACKGROUND

The disclosure relates to an electrohydraulic steering system.

Documents DE 198 01 393 C1 and DE 199 18 225 A1 describe electrohydraulic steering systems in which a main steering cylinder, which is coupled to wheels, is operated by means of a conventional steering wheel and by means of a mechanical or hydraulic main steering system. In addition, a “parallel” hydraulic emergency steering apparatus with a corresponding “parallel” emergency steering cylinder is provided.

Document DE 10 2007 033 990 A1 discloses an electrohydraulic steering system in which the pressure medium stream from a pump is applied to a steering cylinder by the vehicle driver via a hydraulic valve. This pressure medium stream can be assisted by the same pump via a further valve. In this case, the auxiliary pressure medium stream is delivered to the main circuit and therefore to the main cylinder of the steering system.

Also known are electrohydraulic steer-by-wire steering systems in which steering signals from the vehicle driver are electronically transmitted to a hydraulic steering system. Document US 2008/0087014 A1 describes a steer-by-wire steering system of this kind in which pressure medium streams to and from two chambers of a steering cylinder are controlled via various electrically operated valves.

One disadvantage of the last-mentioned electrohydraulic steering system is its level of complexity in terms of hardware for the purpose of reliable disconnection, this involving four proportional valves and two control valves plus a position monitoring means for fault detection.

In contrast, the disclosure is based on the object of providing an electrohydraulic steering system which is inherently reliable (fault tolerant) with a reduced level of complexity.

This object is achieved by an electrohydraulic steering system having the features set forth herein.

### SUMMARY

The electrohydraulic steering system according to the disclosure, in particular for mobile working machines (for example from the fields of agriculture and forestry, from the earthworks and road construction sectors or for handling materials) has a pressure medium supply system from which a first connection, which acts in a first steering direction, can be supplied via a first feed line, while a second connection, which acts in a second steering direction, can be supplied via a second feed line. In this case, the two feeds and also a first return line from the first connection to a tank and a second return line from the second connection to the tank can be controlled via in each case at least two parallel valves. Therefore, in the event of failure of one of the valves, the at least one valve which is connected in parallel can take over control of the corresponding feed line or the corresponding return line. Therefore, inherent reliability (fault tolerance), which is required, for example, to permit the corresponding mobile working machine to be driven on roads, is provided with a reduced level of complexity in terms of hardware.

Further advantageous refinements of the disclosure are set forth herein.

It is particularly preferred for the valves to be electrically operated control valves which are closed in an unoperated state or when no current is flowing. Therefore, the valves also close in the event of the absence of an electrical control signal.

The valves are preferably 2/2 directional valves.

Valves of seat-type design are preferred for the purpose of optimal sealing and minimal leakage. Therefore, jamming of the piston in the open position (seat raised) is virtually precluded.

In order to be able also to tolerate failure of one of the restoring springs which is associated with the respective valve, it is preferred for in each case two redundant restoring springs to be provided.

In a development of the steering system according to the disclosure, the valves are driven in an electrically pulse-width-modulated manner by an electronic control device.

Two electronic control units are preferably provided, wherein two parallel valves of the first feed line and two parallel valves of the second feed line and two parallel valves of the first return line and two parallel valves of the second return line can in each case be controlled independently of one another by one of the two electronic control units. Therefore, failure of a control unit can be tolerated.

If the two electronic control units are supplied independently of one another by in each case one dedicated electrical energy source, failure of an electrical energy source can also be tolerated.

If the two electronic control units are in each case connected to an independent redundant wheel sensor system, failure of a redundant wheel sensor system can furthermore be tolerated.

One preferred exemplary application of the steering system according to the disclosure is a steer-by-wire steering system in which the electronic control device or the two electronic control units is/are connected to a steering apparatus which is operated by a vehicle driver, preferably to a steering wheel, via electrical signal lines.

In a preferred development, the two connections are connected in each case to a chamber of a steering cylinder—preferably of a synchronous cylinder for reasons of symmetry.

If the pressure medium supply system has a first pump and a second pump, which pumps are connected in each case to the first feed line and to the second feed line, failure of a pump can be tolerated.

If, as an alternative, the pressure medium supply system has a pump and a pressure medium reservoir which are connected in each case to the first feed line and to the second feed line, failure of the pump can also be temporarily tolerated since the steering system can be operated or powered by the pressure medium from the reservoir.

### BRIEF DESCRIPTION OF THE DRAWINGS

An exemplary embodiment of the disclosure will be described in detail below with reference to the figures, in which:

FIG. 1 shows a hydraulic circuit diagram of an exemplary embodiment of an electrohydraulic steering system according to the disclosure; and

FIG. 2 shows an electrical circuit diagram of the exemplary embodiment of an electrohydraulic steering system according to the disclosure as shown in FIG. 1.

### DETAILED DESCRIPTION

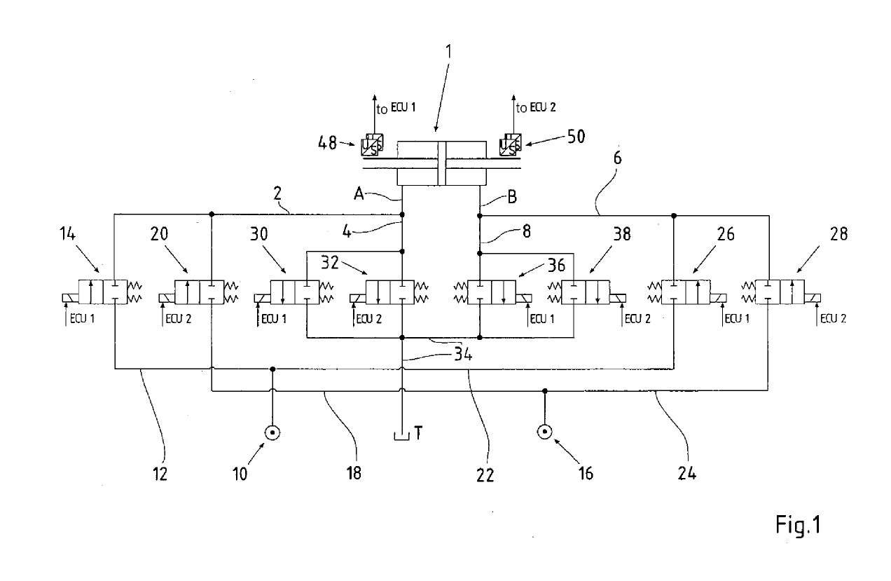

FIG. 1 shows a hydraulic circuit diagram of an electrohydraulic steering system, according to the disclosure, of a mobile working machine. The said electrohydraulic steering system has a steering cylinder 1 which is in the form of a synchronous cylinder and by means of the piston rods of which the steering angles of two wheels (not shown) of the mobile working machine are adjusted. The steering cylinder 1 has a first connection A via which a first pressure space of the steering cylinder 1 is connected to a first feed line 2 and to a first return line 4. The steering cylinder 1 also has a second connection B via which a second pressure space is connected to a second feed line 6 and to a second return line 8.

The electrohydraulic steering system according to the disclosure has a first pump 10 which is connected to the first feed line 2 via a pump line 12 and via a 2/2 directional valve 14. A second pump 16 is also provided, this second pump likewise being connected to the first feed line 2 via a pump line 18 and via a 2/2 directional valve 20.

The two pumps 10, 16 are also connected to the second feed line 6 via corresponding pump lines 22, 24 and via corresponding 2/2 directional valves 26, 28.

The first return line 4 is connected to a tank line 34 via two 2/2 directional valves 30, 32 which are connected in parallel with one another, while the second return line 8 is likewise connected to the tank line 34 via two 2/2 directional valves 36, 38 which are connected in parallel with one another.

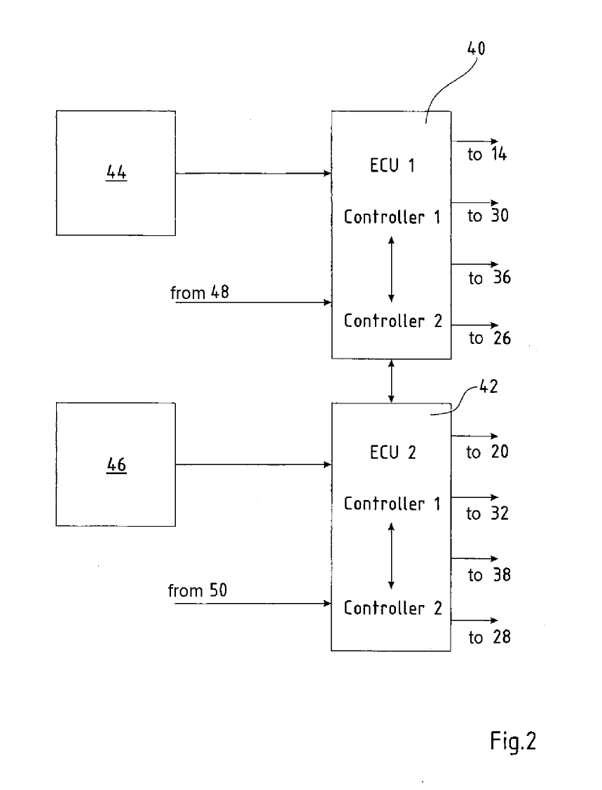

The 2/2 directional valves 14, 20, 26, 28, 30, 32, 36, 38 are in each case illustrated in their basic position in which they are prestressed by two redundant restoring springs and in which the respective pressure medium connection is shut off. When the electromagnets of the said directional valves are activated by an electronic control unit (cf. FIG. 2), the corresponding combinations of feed line 2 or 6 and return line 8 or 4, respectively, are opened, and therefore the piston rods of the steering cylinder 1 are adjusted and the angles of the wheels (not shown) are adjusted.

FIG. 2 shows an electrical circuit diagram of the exemplary embodiment of an electrohydraulic steering system according to the disclosure as shown in FIG. 1.

The electronic control system of the electrohydraulic steering system according to the disclosure will be explained below with reference to FIGS. 1 and 2.

Two electronic control units (ECU) 40, 42 with a respective electrical energy source 44, 46 are provided. The first control unit 40 serves to control the two feed-end 2/2 directional valves 14, 26 and the two discharge-end 2/2 directional valves 30, 36, while the second control unit 42 serves to control the feed-end 2/2 directional valves 20, 28 and the discharge-end 2/2 directional valves 32, 38 which are in each case connected in parallel with the said valves.

Furthermore, the first control unit 40 is connected to a first redundant wheel sensor system 48 via a signal line, while the second control unit 42 is connected to a second redundant wheel sensor system 50. These wheel sensor systems are, in turn, arranged in a redundant manner in relation to one another on the two piston rods, which are coupled to one another, of the steering cylinder 1.

In summary, it can be seen that the following components are in each case redundant in relation to one another according to the disclosure: the feed-end valve 14 in relation to the feed-end valve 20, the feed-end valve 26 in relation to the feed-end valve 28, the discharge-end valve 30 in relation to the discharge-end valve 32, the discharge-end valve 36 in relation to the discharge-end valve 38, the first pump 10 in relation to the second pump 16, the first redundant wheel sensor system 48 in relation to the second redundant wheel sensor system 50, the first control unit 40 in relation to the second control unit 42, and the first electrical energy source 44 in relation to the second electrical energy source 46.

On account of the respectively parallel independent supply of the two pressure spaces of the steering cylinder 1, fault tolerance exists in the feed line 2 and/or 6 in relation to jamming of the feed-end valves 14, 20, 26, 28 in the unoperated position. Accordingly, the first return line 4 from the connection A via two 2/2 directional valves 30, 32 and the second return line 8 of the second connection B via the two valves 36, 38 are likewise redundant and therefore open in a fault-tolerant manner in relation to jamming of a valve in the unoperated position.

A further fault event, which is covered by the steering system according to the disclosure, is failure of a hydraulic or electrical energy supply system 10, 16 or 44, 46 since the supply devices 10, 16 and, respectively, 44, 46 are integrated twice. In the event of a fault in the first pump 10, functionality is maintained by means of the valves 20 and 28 and the second pump 16. When one electrical energy source 44, 46 fails, that control unit 40, 42 which is supplied by the redundant energy source 44, 46 takes over control of the steering cylinder 1 via the valves 14, 20, 26, 28, 30, 32, 36, 38 allocated to it. Furthermore, the data in the redundant wheel sensor system 48 is transmitted to the first control unit 40 and the data in the redundant wheel sensor system 50 is transmitted to the second control unit 42. In the event of a fault in one wheel sensor system 48, 50, the control unit 40, 42 whose wheel sensor system 48, 50 is functional again takes over control of the steering cylinder 1 via the valves 14, 20, 26, 28, 30, 32, 36, 38 associated with it. Furthermore, the two control units 40, 42 in each case comprise a functional unit and a monitoring unit, these units being designated “Controller 1” and “Controller 2” in FIG. 2. Any possibly faulty control unit 40, 42 can be deactivated by the said functional unit and monitoring unit. Furthermore, a cross-check (cf. double-headed arrow) takes place between the two control units 40, 42 according to FIG. 2. The said cross-check serves to interchange information relating to fault events which affect the respective control unit 40, 42, the electrical energy source 44, 46 of the said control unit or the associated redundant wheel sensor system 48, 50.

In a departure from the exemplary embodiment shown, a pump 10, 16 can also be replaced by a pressure medium reservoir. The said pressure medium reservoir is supplied by the remaining pump 10, 16 via a reservoir charging valve.

In a departure from the exemplary embodiment shown, more than two components which are redundant in relation to one another can also be provided in each case.

The disclosure discloses an electrohydraulic steering system, in particular for mobile working machines (for example from the fields of agriculture and forestry, from the earthworks and road construction sectors or for handling materials) having a pressure medium supply system from which a first connection, which acts in a first steering direction, can be supplied via a first feed line, while a second connection, which acts in a second steering direction, can be supplied via a second feed line. In this case, the two feed lines and also a first return line from the first connection to a tank and a second return line from the second connection to the tank are controlled via in each case at least two parallel valves. Therefore, in the event of failure of one of the valves, the at least one valve which is connected in parallel can take over control of the corresponding feed lines or the corresponding return line.

### LIST OF REFERENCE SYMBOLS

1 Steering cylinder
2 First feed line
4 First return line
6 Second feed line
8 Second return line
10 First pump
12 Pump line
14 2/2 directional valve
16 Second pump
18 Pump line
20 2/2 directional valve
22 Pump line
24 Pump line
26 2/2 directional valve
28 2/2 directional valve
30 2/2 directional valve
32 2/2 directional valve
34 Tank line
36 2/2 directional valve
38 2/2 directional valve
40 First control unit
42 Second control unit
44 First energy source
46 Second energy source
48 First wheel sensor system
50 Second wheel sensor system
T Tank

What is claimed is:

1. An electrohydraulic steering system having a pressure medium supply system from which a first connection, which acts in a first steering direction, can be supplied via a first feed line and a second connection, which acts in a second steering direction, can be supplied via a second feed line, wherein the two feed lines and a first return line from the first connection to a tank and a second return line from the second connection to the tank can be controlled via in each case at least two parallel valves.

2. A steering system according to claim 1, wherein the valves are electrically operated control valves which are closed in an unoperated state.

3. A steering system according to claim 1, wherein the valves are 2/2 directional.

4. A steering system according to claim 1, wherein the valves are of seat-type design.

5. A steering system according to claim 1, wherein the valves in each case have two redundant restoring springs.

6. A steering system according to claim 1, wherein the valves are driven in an electrically pulse-width-modulated manner by an electronic control device.

7. A steering system according to claim 6, wherein the electronic control device has two electronic control units, and wherein the two valves of the first feed line and the two valves of the second feed line and the two valves of the first return line and the two valves of the second return line can in each case be controlled independently of one another by one of the two electronic control units.

8. A steering system according to claim 6, wherein the electronic control device has two electronic control units which are supplied independently of one another by in each case one electrical energy source.

9. A steering system according to claim 6, wherein the electronic control device has two electronic control units which are in each case connected to an independent redundant wheel sensor system.

10. A steering system according to claim 6, wherein the electronic control device is electrically connected to a steering apparatus which is operated by a vehicle driver.

11. A steering system according to claim 1, wherein two chambers of a steering cylinder can be supplied via the connections.

12. A steering system according to claim 1, wherein the pressure medium supply system has a first pump and a second pump, which pumps are connected in each case to the first feed line and to the second feed line.

13. A steering system according to claim 1, wherein the pressure medium supply system has a pump and a pressure medium reservoir which are connected in each case to the first feed line and to the second feed line.
